(19) United States
(12) Patent Application Publication
(10) Pub. No.: US 2002/0073574 A1
(43) Pub. Date: Jun. 20, 2002

(54) Gas injection system for a reflow soldering oven

(76) Inventor: Kerem Durdag, Durham, NH (US)

Correspondence Address: Iandiorio & Teska, 260 Bear Hill Road, Waltham, MA, 02451-1018, US

(21) Appl. No.: 09/737,508

(22) Filed: Dec. 15, 2000

(51) Int. Cl. F26B 19/00

(52) U.S. Cl. 34/201

(57) ABSTRACT

A gas injection system for a reflow soldering oven includes a conveyor for moving reflow solder components to the oven from the input to the output through a plurality of heating zones; at least one conduit on one side of the conveyor is adapted for connection to a source of inert gas and a plurality of impingement holes in the conduit proximate at least one of the heating zones blankets the components with inert gas during the solder reflow to reduce the presence of oxygen.

### FIELD OF INVENTION

This invention relates to a gas injection system for a reflow soldering oven.

### BACKGROUND OF INVENTION

Solder reflow ovens convey electronic components both through-hole and surface mount such as printed circuit boards (PCBS) through successive heating zones to melt and reflow the solder to insure good mechanical and electrical joints. Depending upon the size of the oven and the number of heating zones, the last one, two, three or more of the final heating zones may be where the reflow occurs. Depending upon the type of solder used the presence of oxygen in the oven at the reflow time can invade the process and interfere with the mechanical and electrical quality of the solder joints. To combat this an inert gas, often nitrogen, is fed into the oven at a number of points in the oven housing to generally displace the oxygen that enters at the input and output ends of the oven where the conveyor delivers and removes the PCBs. By inert gas herein and throughout this document is meant one which is non-reactive with the constituents of the components and solder to be reflowed. The nitrogen or other inert gas disperses, mixing and circulating with the hot gas, often air, being delivered by the heating zones as impingements jets against the top and bottom surfaces of the PCBs. Depending upon the particular components and solder the oxygen exclusion may be beneficial at earlier stages in the progress through the oven at initial and/or intermediate heating zones. Once the nitrogen is introduced into the oven there is a low level of control over where and how it flows. The average consumption is 1200 standard cubic feet/hour (scfh) to obtain a desired oxygen molecule count of 50 ppm or less. And this measure may be taken anywhere in the oven, e.g., at the nitrogen input pipe or near it which does not give a good indication of the conditions at the PCB surface in the heating zones where the reflow is occurring and oxygen exclusions should be maximum.

### BRIEF SUMMARY OF THE INVENTION

It is therefore an object of this invention to provide an improved gas injection system for a reflow soldering oven.

It is a further object of this invention to provide such an provide an improved gas injection system which controls and directs the inert gas within the oven.

It is a further object of this invention to provide such an improved gas injection system which increases the inert gas pressure and oxygen exclusion at the component during solder reflow.

It is a further object of this invention to provide such an improved gas injection system which creates a blanket of inert gas right at the component.

It is a further object of this invention to provide such an improved gas injection system which produces a blanket of inert gas in the heating zone where the hot gas jets drive the inert gas against the component.

It is a further object of this invention to provide such an improved gas injection system which can utilize the existing conveyor structure of the oven.

It is a further object of this invention to provide such an improved gas injection system which is simple and inexpensive to make and use.

It is a further object of this invention to provide such an improved gas injection system which can use less inert gas to obtain a very low oxygen presence accurately measured at the component.

The invention results from the realization that a truly simple and elegant gas injection system for a reflow soldering oven which assures supply of inert gas at the component during solder reflow can be achieved by disposing alongside the conveyor which transports the components through the oven at least one conduit having a plurality of impingement holes proximate at least one of the heating zones for blanketing the component with an inert gas during the solder reflow to reduce the presence of oxygen.

This invention features a gas injection system for a reflow soldering oven including a conveyor for moving reflow solder components through the oven from the input to the output through a plurality of heating zones. There is at least one conduit on one side of the conveyor adapted for connection to a source of inert gas and a plurality of impingement holes in the conduit proximate at least one of the heating zones for blanketing the components with the inert gas during the solder reflow to reduce the presence of oxygen.

In a preferred embodiment the components may be printed circuit boards, there may be a conduit on each side of the conveyor and the conduit may be included in a guide rail of the conveyor. The impingement holes may be spaced along the inner side of the conduit for providing a lateral injection of the inert gas across the components. The impingement holes may be disposed proximate the last heating zone, the last two heating zones, or the last three heating zones. The heating zones may include a plurality of jets of heated gas which are directed toward the components and drive the inert gas down toward the components. The impingement holes may create a dispersion pattern of overlapping diverging cones. Gas dams may be included to constrain the inert gas in the area of the components.

### BRIEF DESCRIPTION OF THE DRAWINGS

Other objects, features and advantages will occur to those skilled in the art from the following description of a preferred embodiment and the accompanying drawings, in which:

FIG. 1 is simplified diagrammatic sectional view of a reflow soldering oven using a gas injection system according to this invention;

FIG. 2 is an enlarged, detailed view of parts of the gas injection system and conveyor of FIG. 1;

FIG. 3 is a simplified top plan view of a portion of the conveyor and gas injection system of FIG. 2;

FIG. 4 is a side schematic view of a portion of a conveyor guide rail incorporating the conduit and impingement holes for dispersing the inert gas; and

FIG. 5 is a simplified diagrammatic sectional view of a portion of a reflow soldering oven incorporating gas dams for constraining the inert gas near the component.

### DESCRIPTION OF THE PREFERRED EMBODIMENT

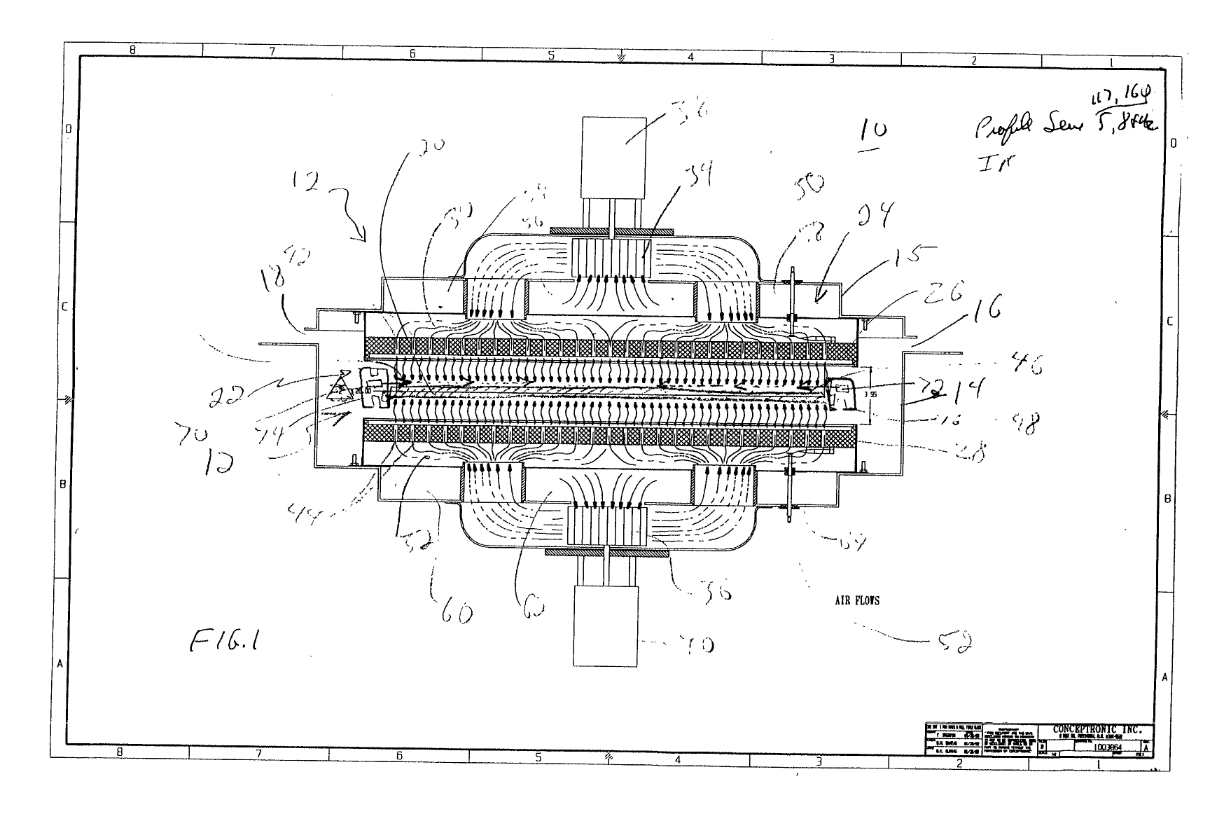

There is shown in FIG. 1 a reflow soldering oven 10 including the gas injection system 12 according to this invention. Reflow soldering oven 10 is a conventional device such as one of the Profile Series of reflow soldering systems sold by Conceptronic, Inc., of Portsmouth, N.H. and disclosed in U.S. patent applications Ser. No. 09/252,745 filed Feb. 19, 1999, entitled “Reflow Solder Convention Oven Multi-Port Blower Subassembly”, by Tallman et al.; and Ser. No. 09/255,080, filed Feb. 19, 1999, “Reflow Solder Convection Oven With a Passive Gas Decontamination Subsystem”, by Durdag et al., all of which are incorporated in their entirety herein by reference. Oven 10 includes a base 14 and cover 15 which are suitably sealed at gaps 16 and 18 by seals not shown.

A component which is to be reflow soldered such as PCB 20 moves through oven 10 by means of a conveyor system 22 which moves PCB 20 into the paper as seen by the viewer in FIG. 1. As it moves into the paper it moves through a plurality of heating zones, only one of which, 24, is shown. Heating zone 24 includes upper and lower heating plates 26 and 28 which interface with plenums 30 and 32. Air is driven into plenums 30 and 32 by blowers 34, 36 driven by their respective motors 38 and 40. As the air moves through heaters 26 and 28, typically electrical heaters, it moves through a plurality of passages 42, 44 where it is heated and then directed as a multiplicity of jets directly onto the top and bottom surfaces 46 and 48 of PCB 20 as indicated by the arrows 50 and 52. The air intake for blowers 34 and 36 are through side ports. Thus blower 34 receives input air through ports 54, 56 and 58 and blower 36 receives input air through ports 60, 62 and 64.

In accordance with this invention, gas injection system 22 includes at least one conduit on one side of the conveyor for blowing an inert gas onto the surface of the PCB 20 when the soldering reflow is taking place as it is here in FIG. 1 at heating zone 24. In this particular case there are actually two conduits 70, 72 making up gas injection system 22 and for convenience and ease of manufacture these conduits 70, 72 are not separate elements but are rather passages in the guide rails 74, 76 of the conveyor system which moves the PCB through oven 10. This of course is not a limitation of the invention as the conduits may be placed on either or both sides and independent of the guide rails.

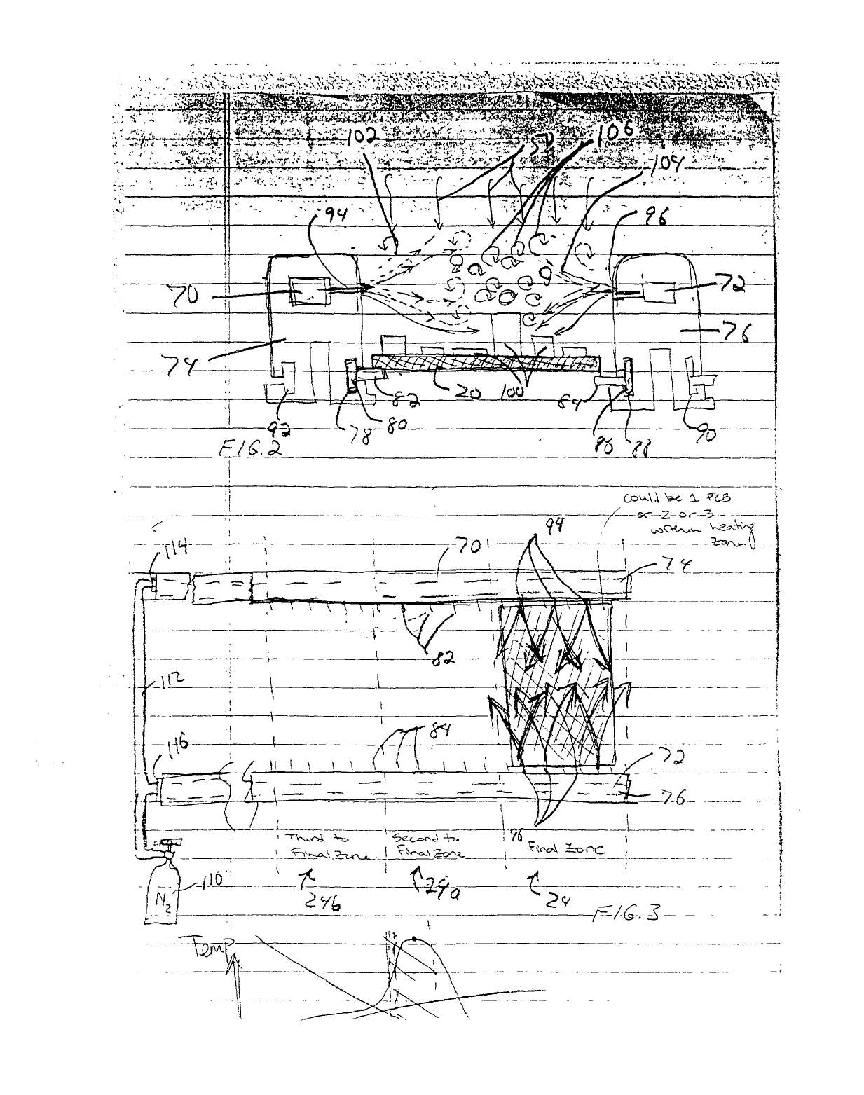

The guide rails also provide a mechanism by which the PCB is supported and transported through oven 10. This can be seen more clearly in FIG. 2 where guide rail 74 has a passage 78 in which is contained a chain 80 similar to a bicycle chain which carries a plurality of pins 82 on which rests one edge of PCB 20. The other edge of PCB 20 rests on pins 84 which are carried by chain 86 in passage 88 of guide rail 76. Additional passages 90 in guide rail 76 and 92 in guide rail 74 may be provided if additional conveying systems are desired to operate in parallel with the one shown. A plurality of impingement holes 94 and 96 direct the inert gas from conduits 78 and 72 outwardly in diverging overlapping cones over the surface of PCB 20. Holes 94 and 96 are positioned high enough so they do not directly hit the elements 100 mounted on the surface of the PCB 20 to avoid dislodging or displacing them by the jets from impingement holes 94 and 96. The inert gas used in conduits 70 and 72 and creating the diverging overlapping cones 102, 104 are a gas which does not react with the solder to be reflowed. By “inert gas” herein is meant any gas which is not reactive with the solder being reflowed. Typically these solders include tin, lead, solder and other elements. While inert gases such as helium, argon, neon and xenon may be used it is cheaper, more practical and more common to use an inert gas such as nitrogen which is also non-reactive with the constituents of the solder to be reflowed.

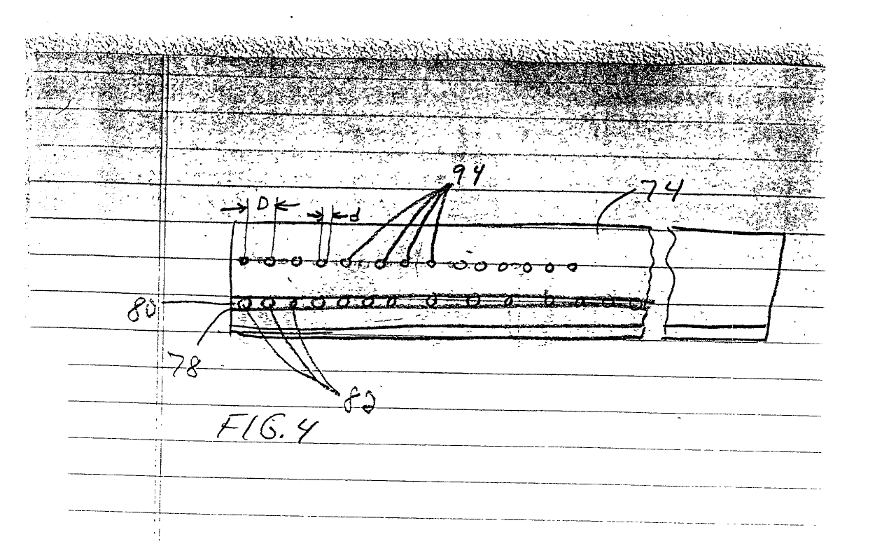

An added advantage of this invention is the fact that the overlapping diverging conical jets 102 and 104 are driven downwardly against PCB 20 during the reflow process by the jets 50 of fluid such as air as indicated by the arrow vortices 106. The pattern of overlapping conical dispersions can be seen more readily in FIG. 3 where the top plan view shows them emanating from both conduits 70 and 72 in guide rails 74 and 76 through impingement holes 94 and 96, in the final heating zone 24, the second to final heating zone 24a, and third to final heating zone 24b. In reflow soldering ovens such as the Profile series referred to hereinbefore, the machines are typically offered with five, eight or eleven heating zones. With five heating zones there is typically but one zone where the reflow soldering takes place, with eight heating zones, typically the last two heating zones are treated as reflow soldering zones, and in the machine with eleven heating zones the last three may be considered reflow solder zones. The inert gas, in this case nitrogen, is fed from a source such as tank 110 through manifold piping 112 into a journal 114, 116 at one end of conduits 70 and 72.

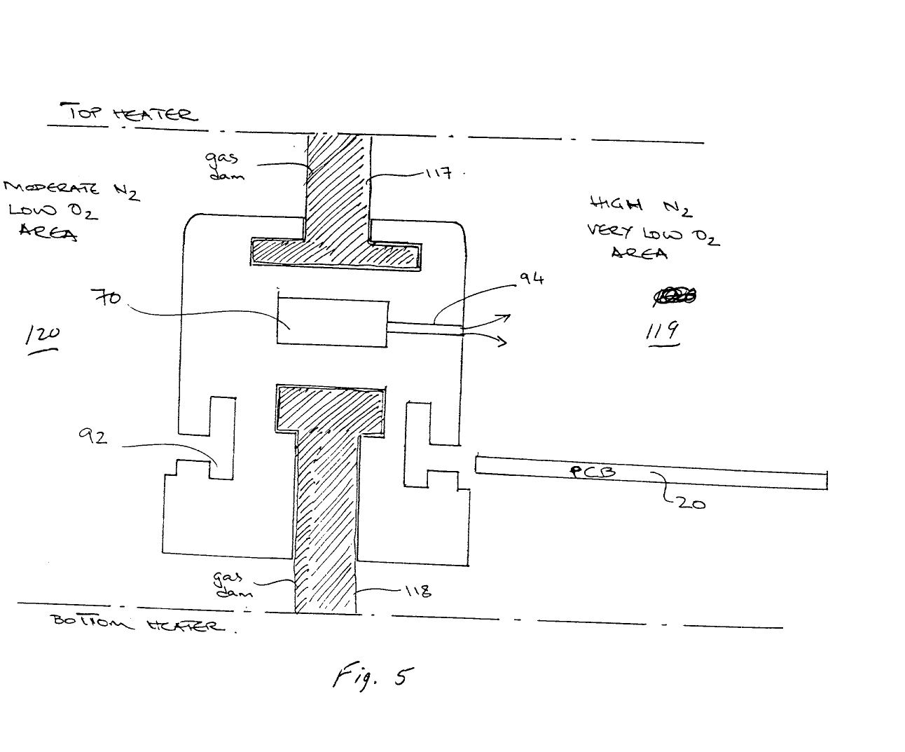

Impingement holes 94, FIG. 4, are typically spaced one inch apart; thus there would be fourteen where the heating zones are each approximately fourteen inches in length. The diameter of the holes is typically 0.067 inch. Thus, in FIG. 4, D is equal to one inch and d is equal to 0.067 inch. This is dictated by the amount and velocity of the flow required as well as the gas being used and the various flow rates in the oven.

As shown in FIG. 5, gas dams 117 and 118 are preferably added to rail 74 to segregate the oven into two separate areas—high inert gas/very low oxygen area 119 and moderate inert gas/low oxygen area 120. Area 119 is where PCB 20 is moving through the oven on the conveyor belt (not shown). This embodiment contrains jets 102 and 104. There is little or no leakage of inert gas into area 120, thereby allowing for lower inert gas usage as well as providing more pressure related control of the inert gas in area 119.

Although in this particular embodiment the resoldering oven shown is a convection oven, this not a necessary limitation of the invention as, for example, the advantages of this invention and its application are suitable for infrared ovens as well.

Although specific features of the invention are shown in some drawings and not in others, this is for convenience only as each feature may be combined with any or all of the other features in accordance with the invention.

Other embodiments will occur to those skilled in the art and are within the following claims:

What is claimed is:

1. A gas injection system for a reflow soldering oven comprising:
a conveyor for moving reflow solder components through the oven from the input to the output through a plurality of heating zones;
at least one conduit on one side of the conveyor adapted for connection to a source of inert gas, and a plurality of impingement holes in said conduit proximate at least one of the heating zones for blanketing the components with the inert gas during the solder reflow to reduce the presence of oxygen.

2. The gas injection system of claim 1 in which said components are printed circuit boards.

3. The gas injection system of claim 1 in which there is a conduit on each side of the conveyor.

4. The gas injection system of claim 1 in which said conduit is disposed in a guide rail of the conveyor.

5. The gas injection system of claim 1 in which said impingement holes are spaced along the inner side of said conduit for providing a lateral injection of the inert gas across the components.

6. The gas injection system of claim 1 in which said impingement holes are disposed proximate the last heating zone.

7. The gas injection system of claim 1 in which said impingement holes are disposed proximate the last two heating zones.

8. The gas injection system of claim 1 in which said impingement holes are disposed proximate the last three heating zones.

9. The gas injection system of claim 1 in which said heating zone includes a plurality of jets of heated gas which are directed toward the components and drive the inert gas down toward the components.

10. The gas injection system of claim 1 in which said impingement holes create a pattern of overlapping diverging cones.

11. The gas injection system of claim 1 further comprising at least one gas dam to constrain the inert gas in the area of the components.
